(19) United States
(12) Patent Application Publication
(10) Pub. No.: US 2002/0099790 A1
(43) Pub. Date: Jul. 25, 2002

(54) Method and system for providing convergent network services

(76) Inventors: Joseph Mosher, Saint John (CA); Jillian Reid, Saint John (CA); Carla MacNeil, Rothesay (CA)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 09/973,146

(22) Filed: Oct. 8, 2001

(30) Foreign Application Priority Data
Oct. 6, 2000 (CA) 2,322,614

(51) Int. Cl. G06F 15/16

(52) U.S. Cl. 709/217

(57) ABSTRACT

A method of organizing access to various multimedia services comprising the steps of: defining a multiple axis framework; locating each said multimedia service within said framework; and allowing a User to select a desired one of said multimedia services by identifying coordinates with respect to one or more of said axes.

The present invention relates generally to computers and communications, and more specifically, to a method and system for providing convergent network services.

### BACKGROUND OF THE INVENTION

At the present time, Users employ multiple devices and methods to access content from different mass media communications outlets, and to access content made available by Providers in a number of different formats.

A news outlet, for example, may cover a single event with a simultaneous combination of television broadcast, radio broadcast, in-depth text/hypertext reports over the Internet and streaming video footage on a private Internet-Protocol (IP) “Fourth Network”. The “Fourth Network” is defined as the radio, TV, telephone & Web mechanisms, other than the “traditional networks”, through which society communicates, exchanges information or consumes entertainment. For example, people buy CDs and DVDs to watch movies, listen to music and play games; they subscribe to newspapers and magazines, buy books or borrow them from the library and rent videotapes. These archived media assets are examples of non-linear content types that have one to one relationships with Users and exhibit characteristics such as “On-Demand” and “Always On”. Their format also provides Users with VCR-like control which allow them to start, stop, rewind and fast-forward content at any time.

In order for a User to access all of the content available from Content Providers, he must use different devices, each of which operates in its own unique fashion. Hence, Content Providers are faced with the challenge of trying to educate their Users about the various media assets they have, their media types, where to find the assets and types, and what tools are required to access them.

If a User wishes to access a content Provider's TV broadcast signal, he has to obtain a television receiver and remember the channel number or station call sign. To locate the content Provider's World Wide Web site, he has to obtain an Internet connected computer and remember the content Provider's URL (uniform resource locator) or use a search engine or portal to locate it. Similarly, if a User wanted to access a radio broadcast, he has to obtain a radio receiver and remember the correct tuning frequency of the radio transmission. Thus, in order to access all of a content Provider's media assets, Users must use multiple appliances and learn numerous navigation metaphors.

There is currently no mechanism for Users to access such various media types in a seamless and intuitive manner.

A number of attempts have been made to make the selection of television channels corresponding to a particular theme easier to accomplish. Each of the issued U.S. Pat. No. 5,673,089; 5,886,746; 5,596,373 and 6,061,097, for example, add a single “theme” layer to the traditional selection of television broadcast channels. U.S. Pat. No. 5,673,089 describes a hand-held remote controller which can be programmed by the User to list certain television channels as sports, news or movie channels. By striking the “sports” key, the User can scroll through those channels which he has listed as “sports” channels. U.S. Pat. No. 5,596,373 is a little more sophisticated in that it offers both “theme” and “sub-theme” selection screens.

In any case, however, the User's ability to organize and select television channels has not been advanced a great deal. With digital and satellite television systems now available, Users can access hundreds of television channels. A User would have to review and categorize all of these channels, and update them regularly, to have a comprehensive system.

As well, none of these patents suggest how the far greater complexity of multiple media sources might be supported. While locally available television channels number in the hundreds, the Internet offers global access to thousands of media sources. Clearly, User-managed organization systems are a completely impractical solution.

A number of attempts have also been made to integrate or connect telephony, data and television networks, as demonstrated in issued U.S. Pat. No. 5,778,056; 5,946,322 and 5,999,612. While these patents describe simple techniques for integrating various network services, they do not integrate these services in a seamless way. Typically, the End User receives telephone signals in a telephone type format, via a telephone channel, and receives television signals in a television format, via a television channel.

U.S. Pat. No. 5,999,612 presents an extreme case, where the End User's personal computer receives separate signals which must be integrated at the End User's PC, requiring the User to have access to all of the disparate networks and to manage those interconnections himself. Clearly, it is impractical to leave responsibility for this complexity to the End User.

There is therefore a need for a system and method which makes the selection of content Provider, content format (video/audio, Internet, telephony, email, and fourth network) and content theme easier to accomplish on connected or integrated communications networks. This solution must be provided with consideration for the problems outlined above.

### SUMMARY OF THE INVENTION

It is therefore an object of the invention to provide a method and system which obviates or mitigates at least one of the disadvantages described above.

One aspect of the invention is broadly defined as a method of organizing access to various multimedia services comprising the steps of: defining a multiple axis framework; locating each multimedia service within the framework; and allowing a User to select a desired one of the multimedia services by identifying coordinates with respect to one or more of the axes.

Another aspect of the invention is defined as a multi media system comprising: an End User terminal; a Service Provider; and a communication network connecting the End User terminal and the Service Provider; the Service Provider being operable to: define a multiple axis framework; locate each multimedia service within the framework; and allow a User to select a desired one of the multimedia services by identifying coordinates with respect to one or more of the axes.

### BRIEF DESCRIPTION OF THE DRAWINGS

These and other features of the invention will become more apparent from the following description in which reference is made to the appended drawings in which:

FIG. 1 presents a flow chart of a broad method of the invention;

FIG. 2 presents a schematic diagram of a multimedia management strategy in an exemplary manner of the invention;

FIGS. 3A through 3H present a flow chart of a method of convergent network system management in an exemplary embodiment of the invention;

FIGS. 4A through 4D present exemplary screen shots of menus in a convergent network system in an embodiment of the invention;

FIG. 5 presents a software block diagram of a convergent network system in an exemplary embodiment of the invention; and

FIG. 6 presents a hardware block diagram of a convergent network system in an exemplary embodiment of the invention.

### DETAILED DESCRIPTION OF THE PREFERRED EMBODIMENTS OF THE INVENTION

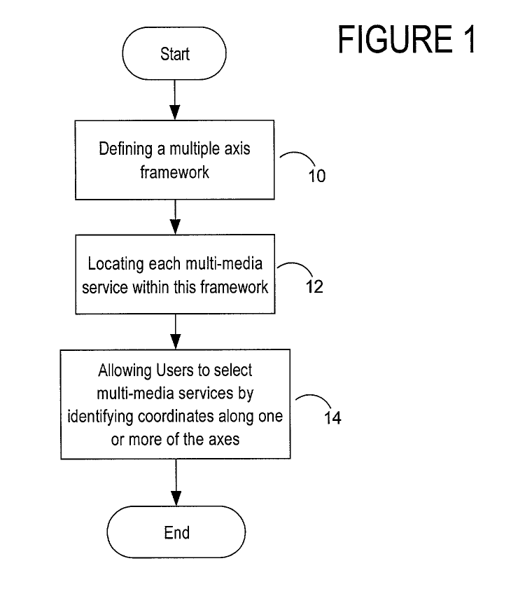

A methodology which addresses the objects outlined above, is presented as a flow chart in FIG. 1. This figure presents a method of organizing access to various multimedia services by performing the steps of:

1. defining a multiple axis framework which spans the multimedia services of interest, at step 10;

2. locating each of the various multimedia services within this multiple axis framework at step 12; and

3. allowing a User to select a desired one of these multimedia services at step 14, by identifying coordinates with respect to one or more of these multiple axes.

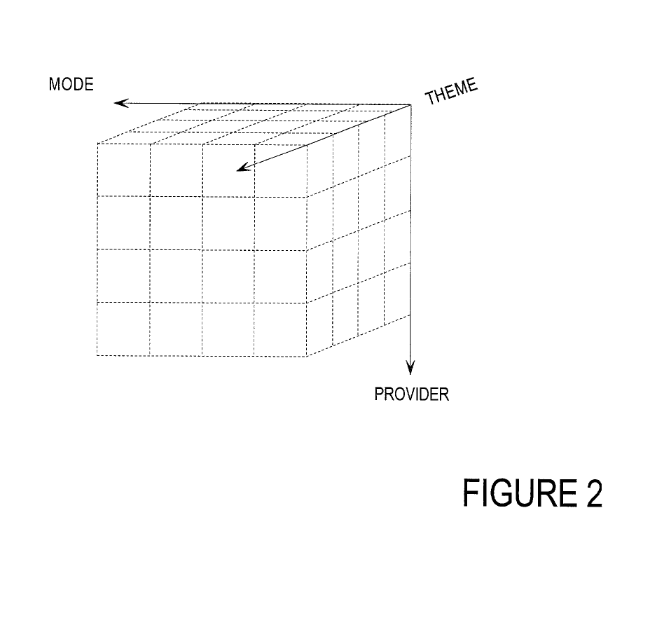

The system of the invention is most easily described with respect to the exemplary schematic diagram of FIG. 2. In this example, a three-axis framework is employed, the axes corresponding to Mode, Theme, and Provider. The “Mode” refers to the physical medium carrying the content, such as a television network, radio broadcast or Internet. The “Theme” refers to the type of content such as news, sports or feature films. The “Provider” refers to the organization or company providing the content, such as the BBC, CNN or Time Warner.

Clearly, other axes could be used including:

media format (such as jpg, mpg, streaming video, RealAudio or HTML),

language (such as English, French, or Spanish), or

cost model (such as free, pay per view, monthly subscription, or cost per block of bits).

As well, more than three axes could be employed.

As noted above, once this framework has been established at step 10, the various multimedia services available are located within this framework at step 12. In the exemplary framework of FIG. 2, simply having three axes with four options for each axis, 64 different categories are available (4³). Providing more options per axis quickly increases the number of categories available, for example, six options for each of three axes providing 216 categories (6³). Similarly, increasing the number of axes available will also increase the number of categories: a system employing four axes with six options per axis would provide 1296 different categories (6⁴). Thus, the thousands of media services available can be managed very easily with minimal complexity for the End User.

The various multimedia services may be supplied via many communication networks as known in the art, and may consist of several different networks working together. These networks may include:

telephone networks, both analogue and digital, the public switched telephone network (PSTN), and wireless telephone networks including cellular and point to point systems;

broadcast, cable and satellite television (TV) and radio networks; and

computer networks including ATM, frame relay, local area networks (LANs), wide area networks (WANs), metronets, Intranets, and the Internet.

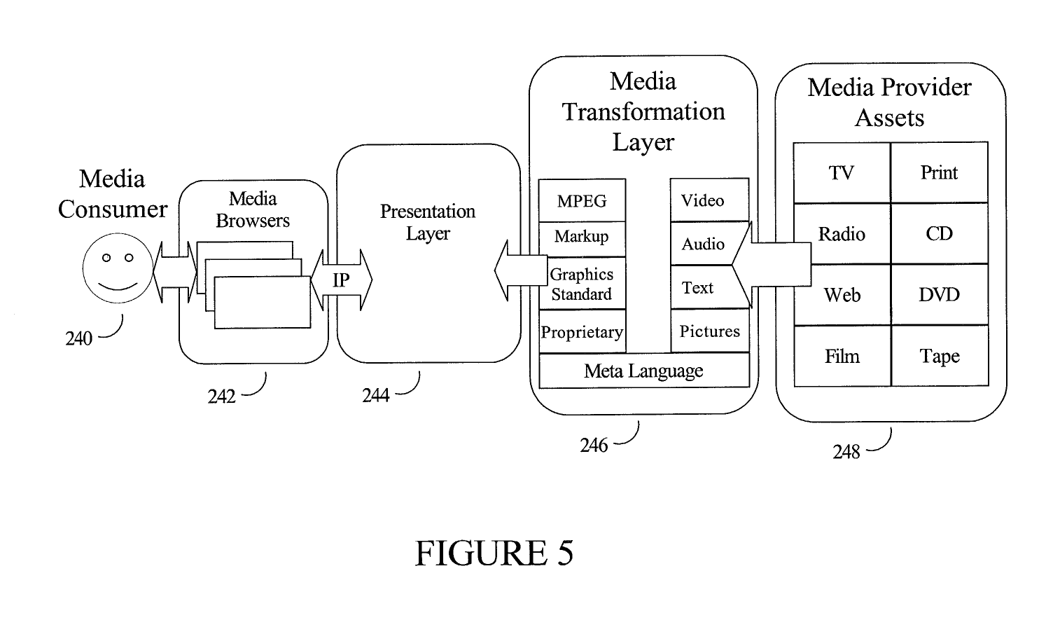

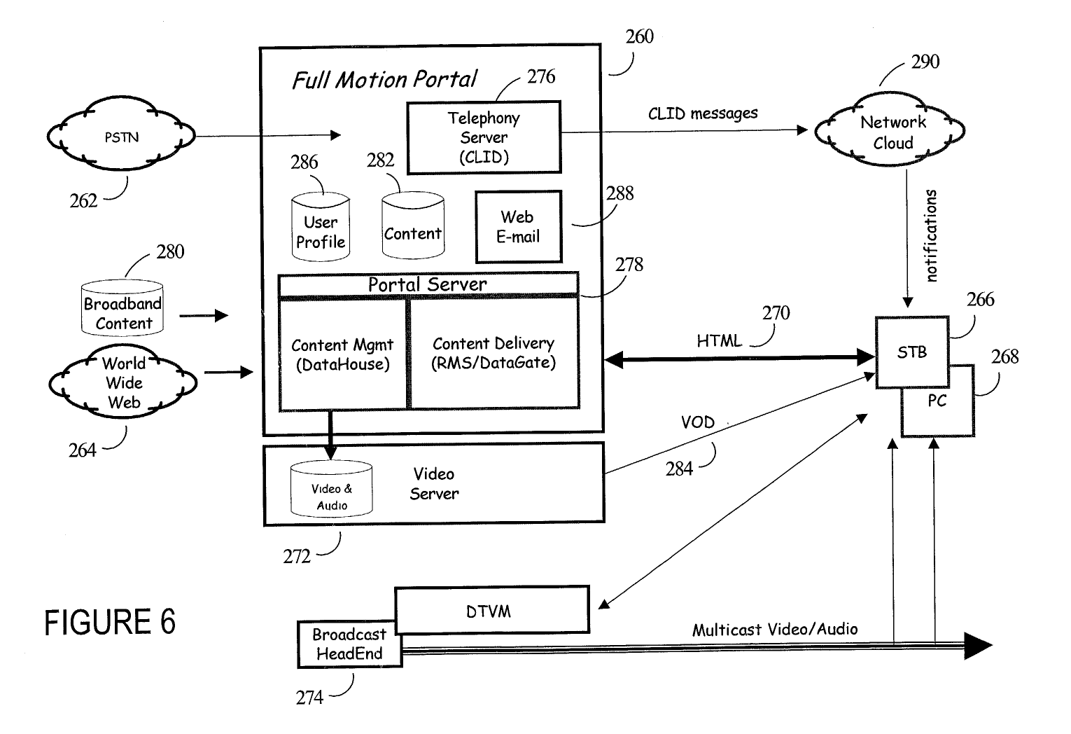

An exemplary system is described hereinafter with respect to FIGS. 5 and 6, which presents one way of integrating such networks.

The invention is not limited by the type of device the End User employs. Though there may be practical or technical limitations to today's networks or devices the invention could otherwise be applied to any manner of electronic devices including computers, smart terminals, personal digital assistants, Internet-ready telephones, information kiosks or other similar interfaces. Such devices are well known in the art.

The software to implement the invention may reside entirely on the End User's device, or entirely on a remote server or portal. It may also combine both local and remote software components, or employ local software which is periodically updated by a remote server. Having any client software provided and updated by a remote server relieves the End User of the burden of having to understand the system, and manage and update it himself.

This invention provides numerous benefits to the Content Providers and the End Users involved.

### Benefits to Content Providers

Using this method, Content Providers can offer their audiences convenient access to all of their media assets. The system of the invention works as both a promotional and educational tool, allowing Content Providers to advertise and offer new media assets to Users. The preferred embodiment of the system also:

1. enables broadcast/cable TV providers to extend their reach and scope beyond their traditional approaches. A television broadcaster could now, for example, direct a user to check a World Wide Web (WWW) site. With the system of the invention, the CBC Web site (the Canadian Broadcasting Corporation traditionally providing television and radio broadcast services) for example, could now provide a button for the End User to click on which would directly access the WWW hyper text link opening it in the new window a split screen or replacing the entire Web page;

2. allows Content Providers to reinforce their brands;

3. allows Content Providers to re-use assets they own or to which they have rights;

4. offers Content Providers the potential for new revenue streams and business models associated with existing content; and

5. allows Content Providers to continue use of their existing telephone or television cable plant, without having to install a new Internet infrastructure.

### Benefits to Users

Users will have a convenient location to discover new media offerings from well-known Content Providers, as the system of the invention aggregates all of a Content Provider's media assets into one location. The system of the invention also enables Users to access companion content to TV and other media assets. As well:

1. Users have a single source for media and no longer have to use a different appliance for every type of media asset they want to access (such as television, personal computer, and radio);

2. these various media can include on-demand and realtime formats;

3. Users no longer have to remember channel line-ups, complicated URLs, radio frequencies or which media player to download;

4. Users can easily find content from a specific content provider;

5. Users can easily move between different forms of media as opposed to switching between sources or physical appliances (i.e. seamlessly); and

6. the system has improved security, as the connection between the End User and his portal may be a private connection (for example, a dial-up modem over a telephone line).

### Detailed Description

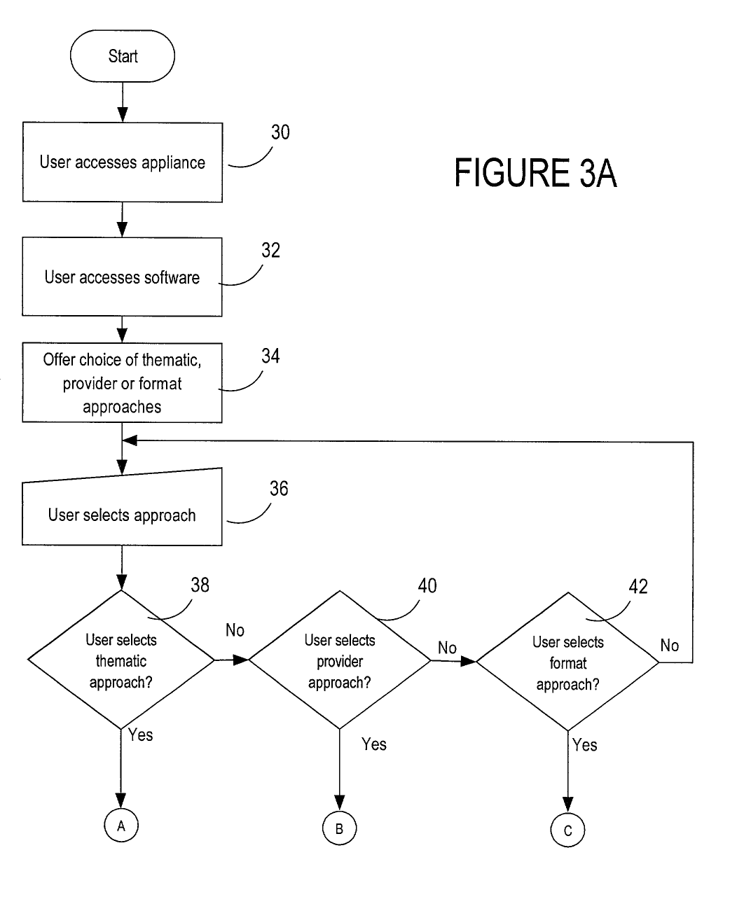

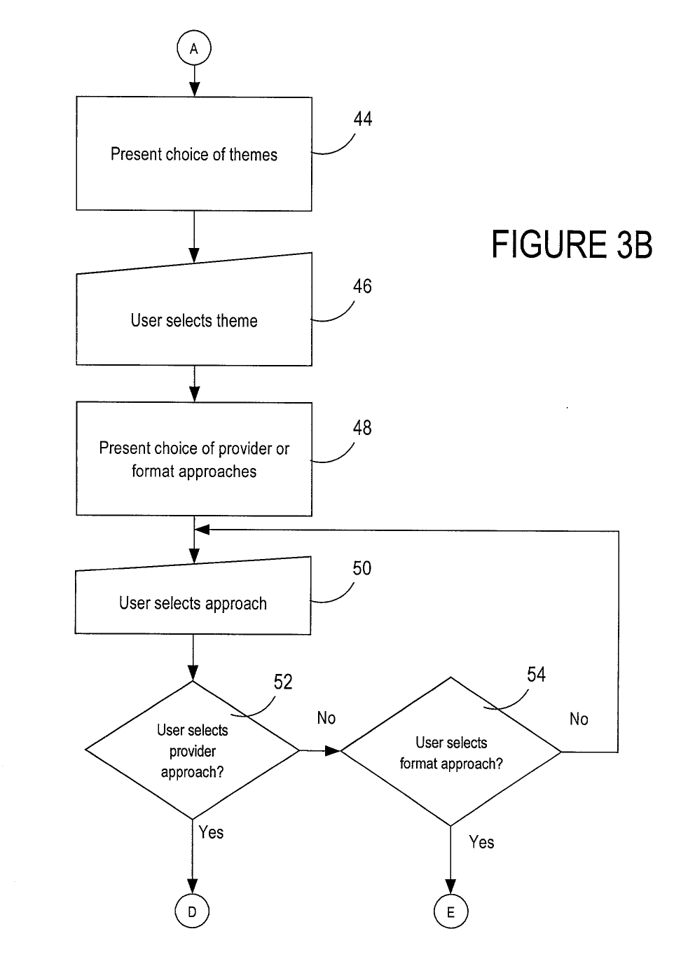

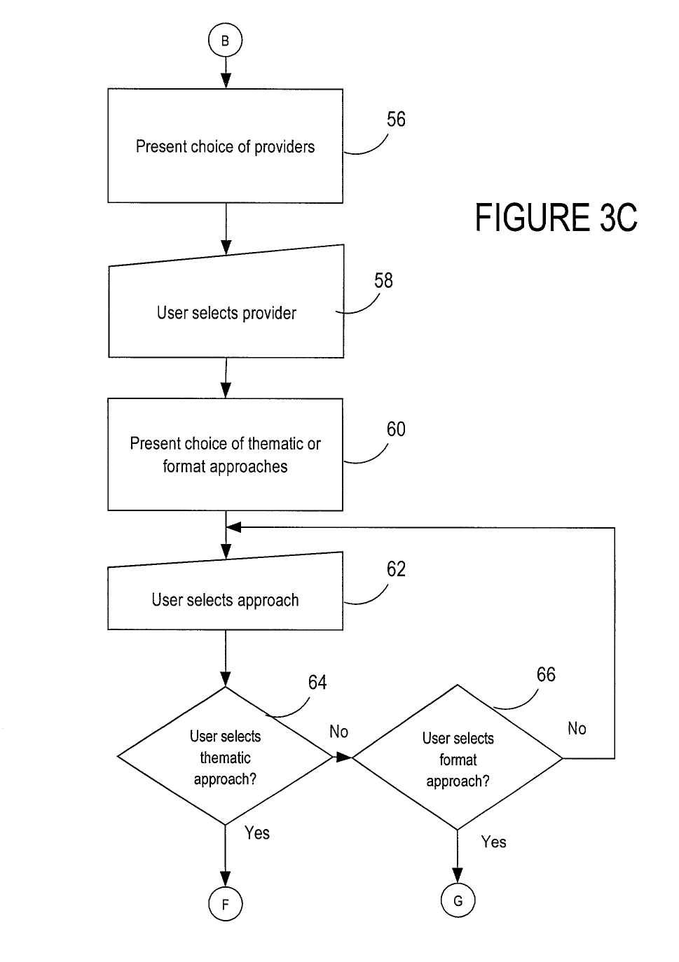

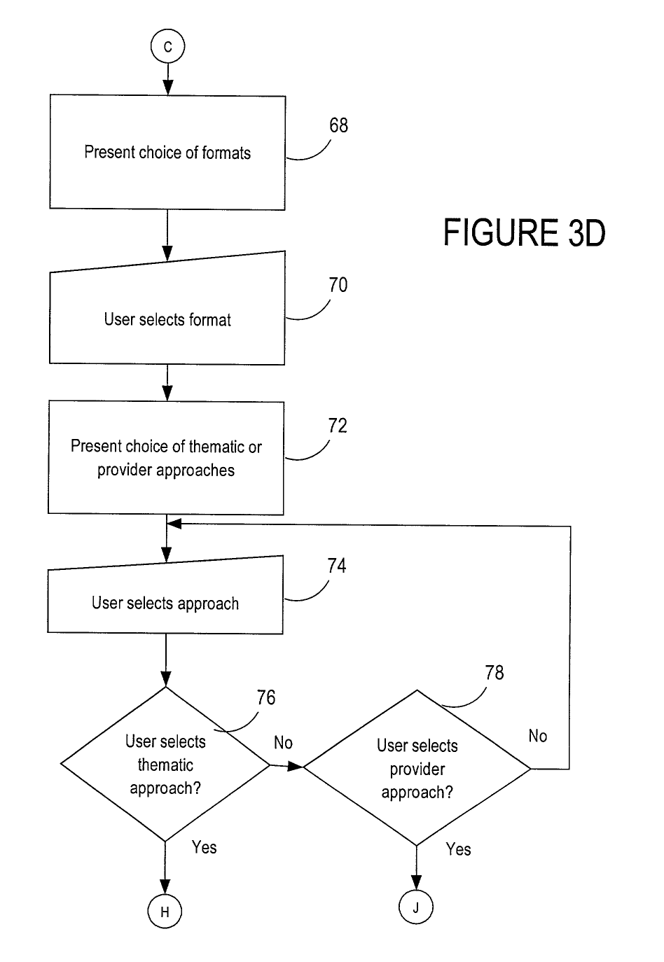

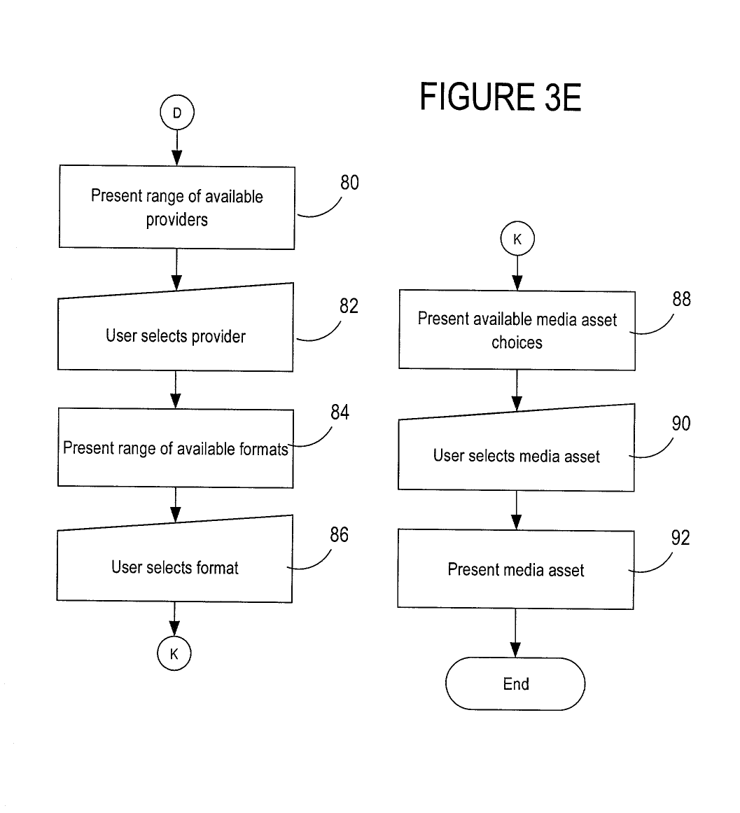

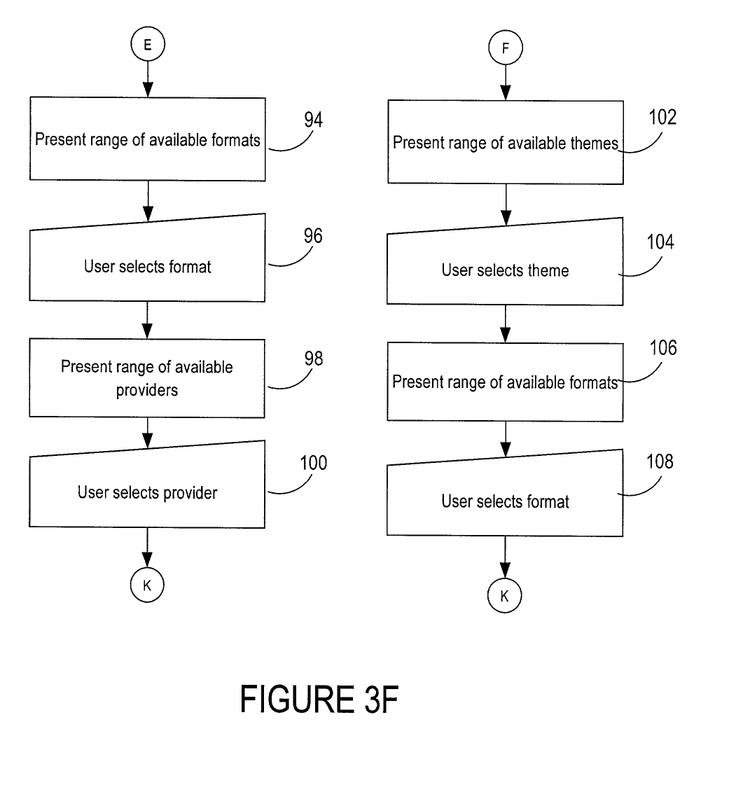

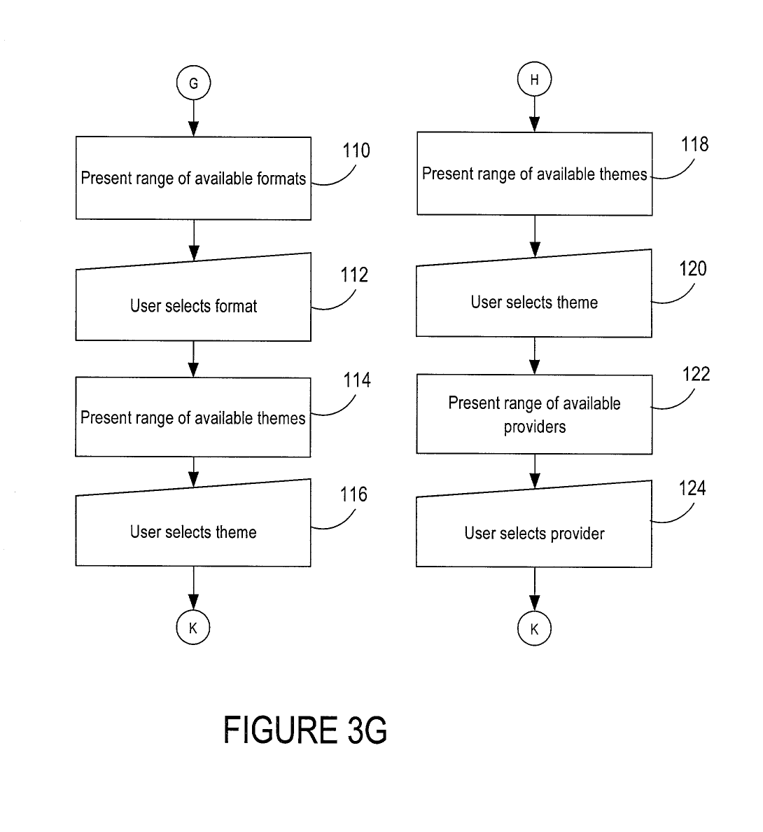

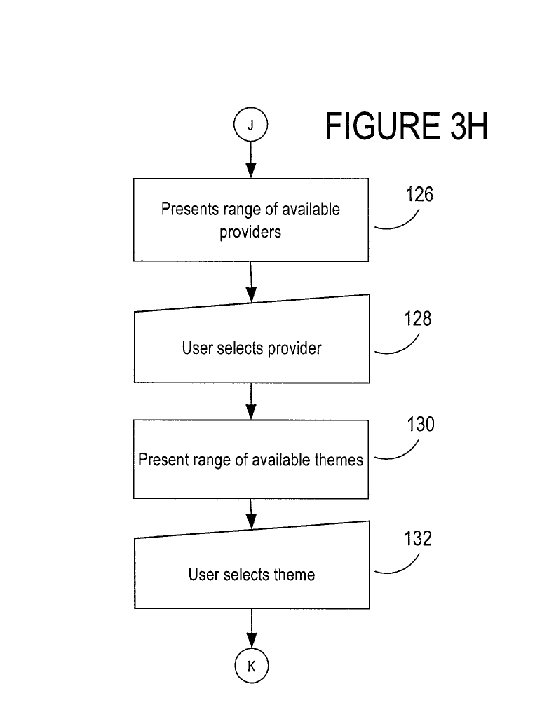

An overview of the preferred embodiment of the invention will first be presented, and then a detailed description given with respect to FIGS. 3 through 6.

In the preferred embodiment, the system of the invention is implemented as a software component of a World Wide Web portal that will provide Users with a mechanism to access content of various media types, from multiple Content Providers, including Broadcast/Cable Television Providers as well as Internet-focussed Content Providers. It provides an on-line directory of Content Providers who offer more than one media asset to Users and it enables Users to choose content from multiple convergent sources: Broadcast TV, the World Wide Web and streaming media (audio and video), video on demand (VOD) for example, within one navigation metaphor and one “Home” page.

The system of invention relates to the creation of a centralized access and delivery point for Users and media Content Providers. It simplifies the process of finding and viewing media content. It allows Users to access various media assets from the appliance of their choice.

The system of invention employs software, which for the first time provides Users with the opportunity to choose the media type they would like to view using their TV remote control or personal computer (PC). In the preferred embodiment, the media assets indexed will include broadcast channels (television or radio), TV-friendly Web sites, streaming video content, streaming audio content, text content and access to that Provider's location in an Interactive Program Guide (IPG).

Of course, the media assets available will depend on the specific content Provider. For example, if a content Provider has a television broadcast channel and streaming video content but does not have a TV-friendly Web site or additional assets, this content Provider may only offer the following options: TV, IPG and video.

The system of invention could be provided by an existing service Provider completely over the Internet, but they may not be able to provide certain formats, such as on-demand video, or television or radio broadcasts. The CNN Web site for example, could provide all of the functionality but would not allow navigation to another content Provider (especially seamlessly).

In the preferred embodiment, the navigation structure is flexible, with the first implementation allowing Users to choose by thematic categories such as Sports, News & Information, Family, Music & Entertainment and Life & Learning. There will also be a category of “Web-only” Providers. These Content Providers offer popular Web sites that are TV-friendly and information rich but do not have additional media assets. The “Web” category will be further broken down into thematic groupings such as Cooking, Pets and Fashion, for example.

The User is presented with the Content Providers available under that particular content category. The User selects a content Provider and is presented with information about that particular content Provider as well as the media types that he can access from that source (eg: TV, streaming radio, web, video clips, audio clips, etc.). The Content Provider/Service Provider determines the media types and assets to which it will offer Users access.

When the User selects a media type, he is presented with a list of assets to view or access, for example:

1. a broadcast TV channel (or a list of available channels if the Content Provider has more than one);

2. a Web site; or

3. a list of short video clips available to view.

A “Web-only” category under the system of the invention promotes TV-friendly, information-rich Web sites. The Content Providers under this category would be those that have a Web site only. This Web only category is broken down into thematic groupings such as Books, Entertainment, Music and Lifestyle.

The preferred embodiment of the invention is as presented in the attached figures, but depending on the implementation, there may be advantages in applying the invention in the following manners:

1. all communications are IP (Internet Protocol) based but are not necessarily carried over the Internet;

2. the main software is provided as a graphic User interface (GUI) (content is not Web content), as opposed to a Web site, that is, the system of the invention is marketed not as a destination portal but software that will be sold to others which they load on their servers;

3. the STB (Set Top Box) is a standard device with a Web browser.

Customization is done by the portal downloading a customized HTML page (hypertext markup language) to the STB;

4. “notifications” identified in FIG. 6, refers to stripping the CLID (calling line identification) from an incoming telephone call and presenting it on the End User's television screen or computer (i.e. displaying on the screen “you have received a telephone call”). Otherwise the interaction of the system of the invention with the PSTN (Public Switch Telephone Network) is generally as a conduit;

5. the portal can make agreements to access network side services which avoids the logistical problems of small bills;

6. the portal could store broadband content for redistribution on demand basis;

7. use of an intermediate meta language as shown in FIG. 5; and

8. personal preferences could be stored on a server, providing a profile for each End User or account.

Other specific aspects of the system of the invention include:

1. Three-Axis Indexing:

As described above, access to content is preferably indexed with respect to three axes: mode, Provider and theme. Typically, these three axes will be used as three different layers in the graphic User interface (GUI) though the ordering of the layers may be varied. Some portals, such as Gemstar, use a two axis approach, for example, allowing the User to select by Provider and theme but not mode. Other methods and systems known in the art may use two axes in combination but not three or more.

Some implementations, for example, may use separate pairing of theme and Provider but for different modes. Therefore, the User must switch from one mode to another, for example, going from personal computer to television to cellular phone; each device comprising a different mode. The problem with such a model is that End Users have to constantly shift paradigms: they have to be aware of which plane they are on, where they want to go and understand how each different plane is designed. The system of the invention provides a solution by integrating access to make the various planes transparent to the End User, so he can move quickly, easily and seamlessly from one content Provider or format to another.

The system of the invention preferably implements the three axis methodology by providing:

a way to access content;

a way to index content; and

a portal at the service Provider which integrates the various contents.

Such a system is described in detail in FIGS. 3 through 6.

Content Providers may be under contract or license, while some may be in the public domain. Some may provide the same content in more than one form, for example, providing video programming via both Real Audio™ World Wide Web (WWW) streaming, and also broadcast via television cable. Internet transmissions may provide the same content as the television broadcast, or enhanced content.

Having indexing that spans the networks, provides tremendous opportunities for new business and media models. For example, a television broadcast could direct a User to visit a WWW site. With the system of the invention, the broadcaster's Web site could now include a button for the End User to click on which would directly access a hyper text link opening a new window, a split screen or replacing the entire Web page.

2. Content Conversion

The system of the invention may be implemented as shown in FIGS. 5 and 6, where a driver mechanism is provided for each input and output. The selection and conversion of formats may be implemented using a common API (Application Programming Interface), or meta language.

Inputs may, for example, include Internet protocol (IP), SS7 (Signalling System 7—a telephony protocol), TV band transmissions, or radio band transmissions. Outputs may, for example, include WAP (Wireless Access Protocol), IP/XML (Internet Protocol/Extensible Markup Language), IP/HTML (Internet Protocol/Hyper Text Markup Language) or Digital TV.

Other input and output formats could easily be added to the system of the invention. One skilled in the art could add the necessary interface hardware and software drivers to build on the invention.

3. Logistics of Coordinating Networks

The system of the invention provides a single point of contact for handling the logistics of billing and monitoring usage of services. Integration of the services at the portal instead of at the End User's computer, as in the case of U.S. Pat. No. 5,999,612, provides many such advantages.

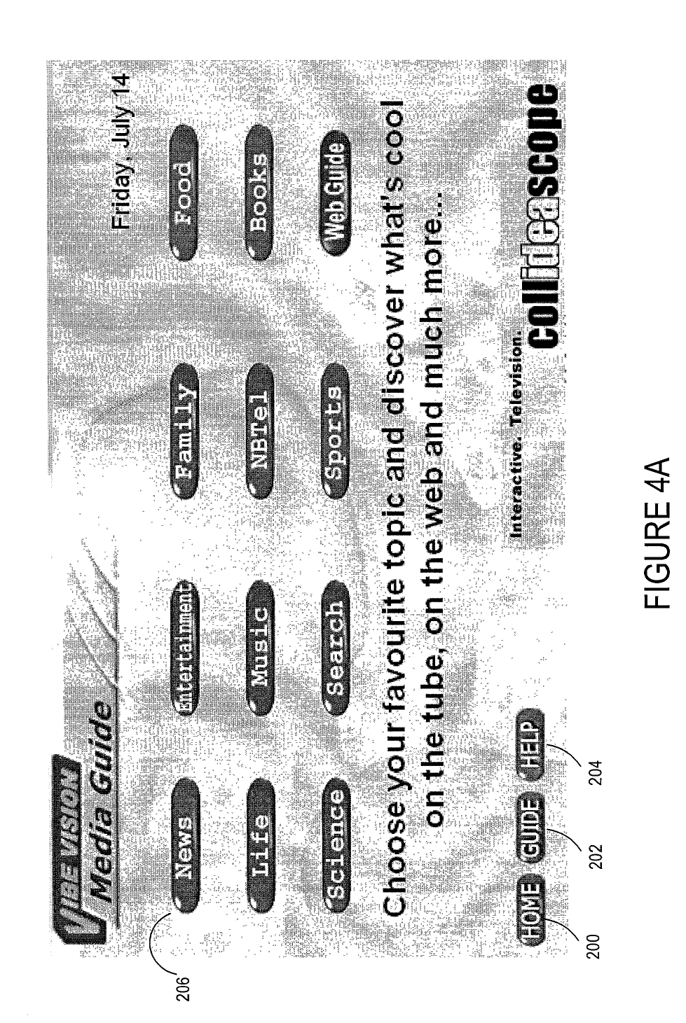

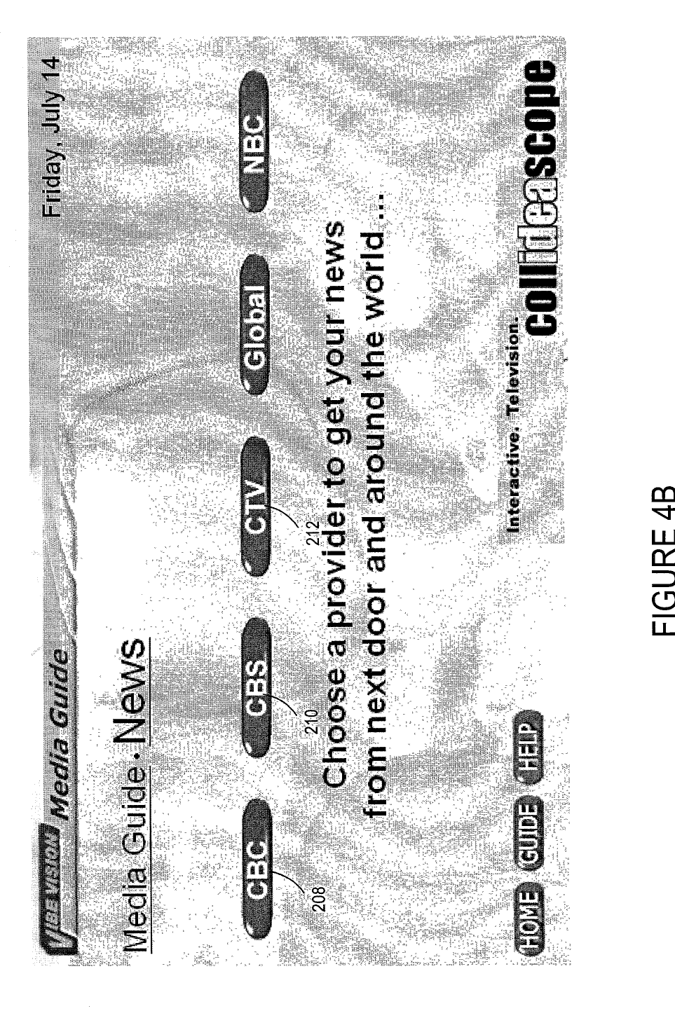

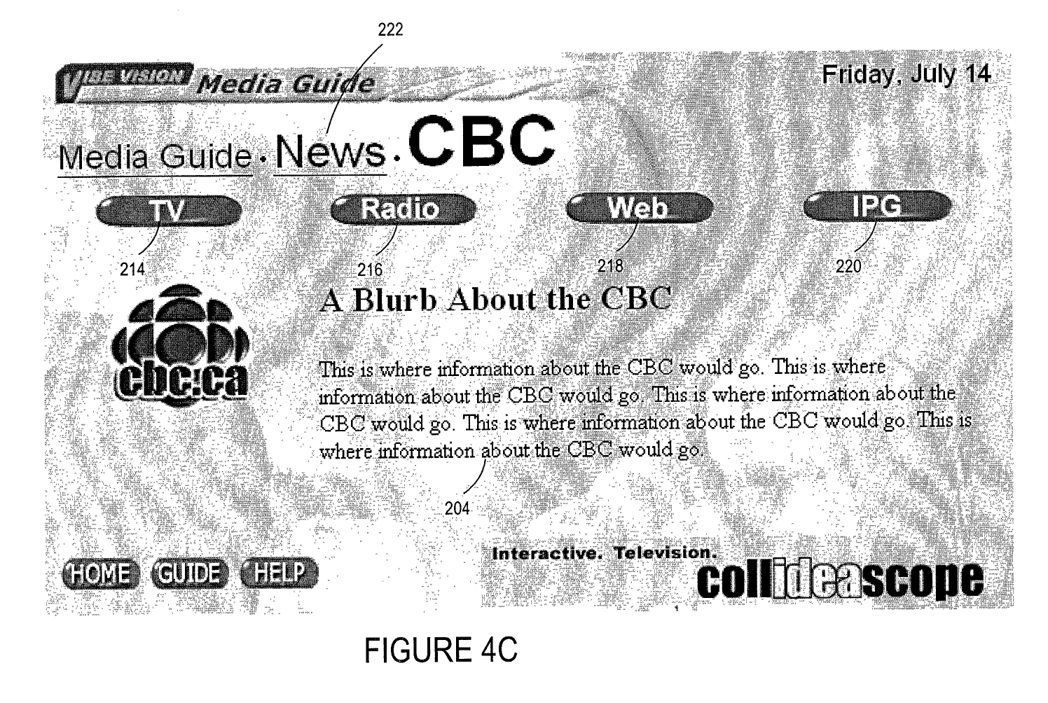

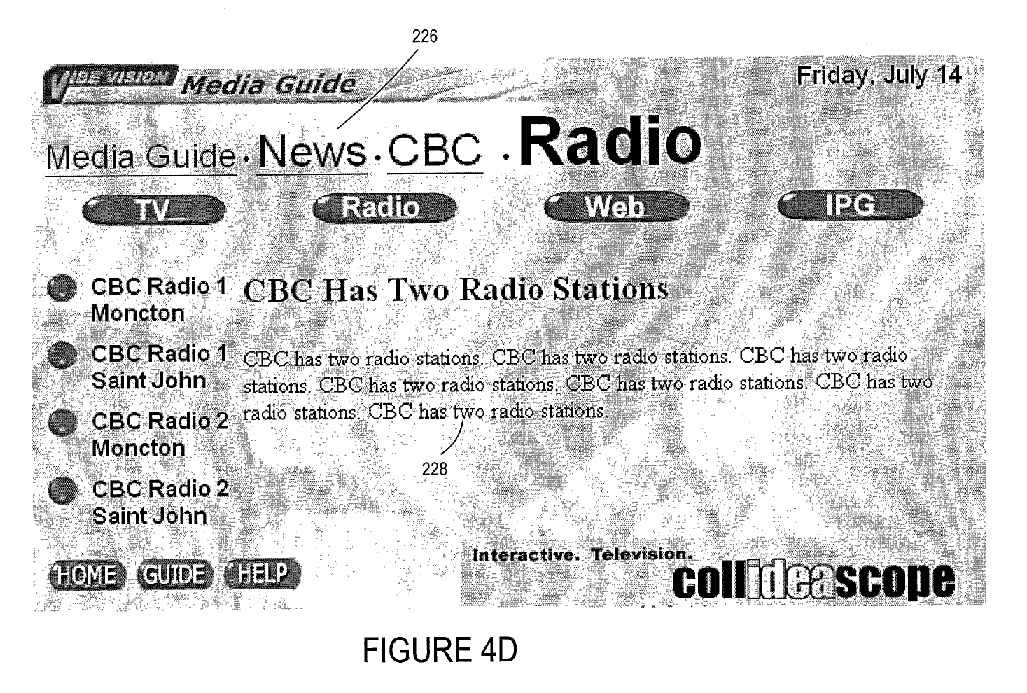

The preferred embodiment of the invention will now be described with respect to FIGS. 3 through 6. FIG. 3 presents a flow chart of the three-axis management process, and FIG. 4 presents exemplary screen captures that may accompany such an implementation. FIGS. 5 and 6 present block diagrams of the preferred system of the invention; FIG. 5 presenting the software layering and structure and FIG. 6 presenting the hardware structure.

The process begins when the User accesses his electronic appliance at step 30 of FIG. 3A. As noted above, this appliance will typically be a personal computer with a set top box, but is not so limited.

When the User wishes to access multimedia services supported by the system of the invention, he will initiate the software at step 32. In response, the software will offer the User the choice of whether to take a thematic, Provider or format based approach to identifying a media selection, at step 34.

If the User selects a thematic approach at step 36, step 38 will route control via link A, to step 44 of FIG. 3B. Similarly, if a Provider based approach is selected, step 40 will route control via link B, to step 56 of FIG. 3C, and selecting format-based approach at step 36 will route control via step 42 and link C, to step 68 of FIG. 3D.

If the User has selected the thematic approach at step 36 of FIG. 3A, control passes to step 44 of FIG. 3B, where the User is presented with a choice of themes. The User selects the theme he desires at step 46, and in response, he is provided with a choice of whether to next identify the desired Provider or format, at step 48.

If the User selects a Provider approach at step 50, then control passes via step 52 and link D, to step 80 of FIG. 3E. Similarly, if the User selects a format approach at step 50, then control passes via step 54 and link E, to step 94 of FIG. 3F.

FIGS. 3C and 3D are structured in a similar manner.

If the User has selected the Provider approach at step 36 of FIG. 3A, then control passes to step 56 of FIG. 3C, where the User is presented with a choice of Providers. The User selects the Provider he desires at step 58, and in response, he is provided with a choice of whether to next identify the desired theme or format, at step 60.

If the User selects a thematic approach at step 62, then control passes via step 64 and link F, to step 102 of FIG. 3F. Similarly, if the User selects a format approach at step 62, then control passes via step 66 and link G, to step 110 of FIG. 3G.

If the User has selected the format approach at step 36 of FIG. 3A, control passes to step 68 of FIG. 3D, where the User is presented with a choice of formats. The User selects the format he desires at step 70, and in response, he is provided with a choice of whether to next identify the desired theme or Provider, at step 72.

If the User selects a thematic approach at step 74, then control passes via step 76 and link H, to step 118 of FIG. 3G. Similarly, if the User selects a Provider approach at step 74, then control passes via step 78 and link J, to step 126 of FIG. 3H.

The algorithm has now been split up into six different paths which are handled follows:

first selection by theme, second by Provider: the User is presented with a list of available service Providers at step 80 of FIG. 3E. When the selection is made at step 82, the User is presented with a range of available formats at step 84, from which he makes a selection at step 86;

first selection by theme, second by format: the User is presented with a list of available formats at step 94 of FIG. 3F. When the selection is made at step 96, the User is presented with a range of available Providers at step 98, from which he makes a selection at step 100;

first selection by Provider, second by theme: the User is presented with a list of available service themes at step 102 of FIG. 3F. When the selection is made at step 104, the User is presented with a range of available formats at step 106, from which he makes a selection at step 108;

first selection by Provider, second by format: the User is presented with a list of available formats at step 110 of FIG. 3G. When the selection is made at step 112, the User is presented with a range of available themes at step 114, from which he makes a selection at step 116;

first selection by format, second by theme: the User is presented with a list of available themes at step 118 of FIG. 3G. When the selection is made at step 120, the User is presented with a range of available Providers at step 122, from which he makes a selection at step 124; and

first selection by format, second by Provider: the User is presented with a list of available Providers at step 126 of FIG. 3H. When the selection is made at step 128, the User is presented with a range of available themes at step 130, from which he makes a selection at step 132.

In each case, the control flow then passes via link K to step 88 of FIG. 3E, where the User is presented with a list of available media asset choices. The User selects the desired media asset at step 90, and is provided with the media asset at step 92.

FIGS. 4A through 4D present screen shots of an exemplary implementation of the invention. In FIG. 4A, for example, the User is presented with a view of the various themes that may be accessed, including news, entertainment and family themes. Other themes are also shown, and of course, the number of themes that could be used is unlimited.

The User is also given the option of selecting on each screen:

the “home” button 200, which will send the User to the home page of the service Provider;

the “guide” button 202, which will return the User to the initial screen of the software of the invention (the “Media Guide™” software); or

the “help” button 204, which will provide instructions to the User.

If the User selects the “news” button 206 from the menu in FIG. 4A, he will be sent the “news” page which appears in FIG. 4B. Note that the “selection” of menu items can be done using any method known in the art, including: locating a cursor using a mouse and clicking a button on the mouse, using a Tab key to cycle through the various options available, using control keys, for example, <CNTRL><N> to represent “news”. Many other input techniques are known, particularly for other devices such as PDAs and cellular telephones. Such techniques would be known to one skilled in the art.

FIG. 4B presents a list of available news service Providers, such as CBC 208, CBS 210 and CTV 212. If the User then selects the CBC entry 208, he will be sent to the screen appearing in FIG. 4C which allows him to select the format of the CBC media presentation. As shown, this may include television (TV) broadcasts 214, radio broadcasts 216, Web page 218 or an Interactive Program Guide (IPG) service 220. Note that this screen also identifies the previous selections made along the top of the screen 222, and provides textual information about the selected Provider 224.

If the User selects “radio” 216 in FIG. 4C, he will then be provided with the list of radio assets in the left hand column of FIG. 4D which correspond to the selected theme (news), Provider (CBC), and format (radio). Like FIG. 4C, the User is also given a listing of his selections that brought him to this screen 226, as well as textual information about the available selections 228.

FIG. 5 presents the system of the invention in terms of layers. As described above, the User 240 accesses the various multi media services via Web browsers 242 who communicate with the system of the invention using IP (Internet Protocol). A Web browser is a software application used to locate and display Web pages. The leading Web browsers currently available for personal computers are graphical browsers, meaning that they can display graphics as well as text. They also support a variety of multimedia data, including sound and video, though they require software plug-ins for some formats. Browsers for cellular telephones and the like, with limited multimedia interfaces and downloading bandwidth, have more limited functionality.

The Presentation Layer 244 coordinates the selection of services from the Media Transformation Layer 246. The Media Transformation Layer 246 is typically a hardware component that receives content from the Media Provider Assets 248, and converts them into formats that can be communicated digitally.

In the preferred embodiment, the Media Transformation Layer 246 receives content in various formats and various electronic forms (such as the video, audio, text and picture formats identified in FIG. 5). These various data are converted into a standard, intermediate “meta language”. The data in the meta format will then be converted to a format appropriate for transmission in an IP format (such as MPEG, markup, graphic standard or some proprietary format as shown).

The use of a meta language allows great flexibility in implementation. If a new incoming format is to be supported, it is only necessary to develop an appropriate input driver; the balance of the system remains unchanged. Similarly, if a new output format is to be provided, it is only necessary to develop a new output driver to support the new format.

FIG. 6 presents a block diagram of the physical components which make up the preferred embodiment of the invention.

At the heart of the design lies the “Full Motion Portal” 260 which interconnects End Users with the broad range of communication media available. These media may come from external sources including the PSTN (Public Switched Telephone Network) 262, World Wide Web 264, and Broadband Content Providers 280 and their systems, and content may also be maintained in local or internal storage devices 282.

This content is communicated with the User via his set top box 266 and personal computer (PC) 268, using HTML (hypertext markup language) 270. HTML is a system for organizing and tagging elements of a document, designed especially to determine how Web pages are formatted and displayed.

The Full Motion Portal 260 also supervises a video server and storage facility 272 which provides streaming audio or video to the User using IP (Internet Protocol). This content may be provided using a video on demand (VOD) model as shown 284, but is not so limited.

A third source of media content to the User is real-time audio and video content which may be multi-cast via the Broadcast Headend and digital television manager (DTVM) 274.

Note that multiple connections are shown to feed the STB 266 and PC 268, but all of these communication channels may be carried in a single physical connection, for example, via a television cable.

The Full Motion Portal 260 is built around two servers, though any number of servers could be used to perform the same tasks. A server is simply a computer or device on a network that is optimised to perform a particular function, generally for a number of clients on the network. In the case of the Full Motion Portal 260, two servers were used: a database server designed to store large quantities of digital content and quickly retrieve it when required, and an application server optimised to store and execute the system software described hereinafter. The telephony server 276 and portal server 278 were implemented using a single application server in the preferred embodiment of the invention.

The components and arrangement of the telephony server 276, portal server 278 and other elements of the Full Motion Portal 260 such as the user profile database 286 and Web email 288, are described in greater detail hereinafter with respect to the actual software and hardware used to implement them in the preferred embodiment. Briefly though, the User profile database 286 maintains records of User preferences, passwords, billing and usage of services. This allows the Full Motion Portal 260 to integrate the billing and monitoring of diverse media services at a single location.

The operation of the PSTN 262 and telephony server 276 system was described briefly above. In general, telephone calls may be received from the PSTN 262, by the telephony server 276. The telephony server 276 forwards calling line identification (CLID) messages to the End User for presentation on their television screen or PC 268. The network cloud 290 presented in FIG. 6 simply recognizes that the notification messages may pass through various routers or other devices before they arrive at the End User's equipment. As noted above, apart from the notification to the End User, the Full Motion Portal 260 and associated components of the system simply act as a conduit between the PSTN 262 and the End User.

In the preferred embodiment, Sun Enterprise-class servers (Sun 220R) were used for the two servers of the Full Motion Portal 260. These servers offer the following advantages:

high degree of functionality;

reliability;

scalability; and

high degree of industry-wide acceptance.

The configuration required for this hardware was basic set-up and installation, which included software and network interface components.

The Full Motion Portal 260 requires a large number of software components to provide the full functionality of the system of the invention. Unless noted otherwise, the following software packages were used without any particular installation and configuration requirements beyond those required for standard installation in the immediate operating environment.

The foundation of the software system is the Sun Solaris operating system (O/S) Version 2.6. This is a UNIX™ based network operating system that offers the following:

features dedicated to “large files” (over 2 Gigabytes);

TCP/IP based networking;

multithreaded processor necessary for real-time or near real-time applications; and

Java enabled features.

Java is a general purpose high level programming language with a number of features that make the language well suited for use on the World Wide Web. Java is an object-oriented language similar to C++, but has been simplified to eliminate features that commonly cause programming errors. Compiled Java code can run on most computers because Java interpreters and runtime environments, known as Java Virtual Machines (VMs), exist for most operating systems, including UNIX, the Macintosh OS, and Windows.

Small Java applications are called Java applets and can be downloaded from a Web server and run on your computer by a Java-compatible Web browser, such as Netscape Navigator or Microsoft Internet Explorer.

The operating system chosen for an implementation must be loaded on each server, so it must be compatible with, and supported by each server. An operating system is a software package that performs basic tasks, such as interfacing a computer with hardware components such as keyboards and disk drives, manages memory and CPU operation, and provides a software platform on which application programs can run.

The Solaris O/S software was also selected due to its acceptance in the industry, and because of its capabilities and reliability. This version of the O/S was the current version in use when the software of the invention was created.

The configuration required for this software was that a certain patch level for the O/S was required for the O/S to support various software components, such as the Oracle database, iPlanet Web server and the Sun Java Development Kit.

The content database server was also supported by Oracle 8i Database software Standard Edition V8.1.6. This is a relational database which is used to store content and associated meta data, as well as details regarding portal Users and User profile information, plus navigational details for the User experience. A relational database is a type of database that stores data in the form of related tables. Relational databases are powerful because they require few assumptions about how data is related or how it will be extracted from the database. As a result, the same database can be viewed in many different ways.

This database software was chosen as it is considered to be an industry standard and as such is widely deployed and supported. The configuration required for this software is that a database table schema must be constructed, plus the standard install process must be performed to configure it for use on the specific server.

The balance of the software on the Full Motion Portal 260 resides on the application server:

1. Oracle 8i Database Client V8.1.6

This software is used to connect and manipulate data within the database.

This software was selected due to its compatibility with the database software.

The configuration required for this software was that connection parameters to access the database server must have been specified.

2. iPlanet Web Server V4.1, Service Pack 7

This Web server software is used to deliver HTML content to customers.

This software was chosen since it offered full support for Java server “servlets” and Java server pages. The existence of a Sun, iPlanet and Oracle alliance makes for smooth inter-operability. Service Pack 7 of the software was chosen specifically since it offered the highest security and most stability of the latest version available.

There was a great deal of configuration required for this software to define the necessary application and software components required, plus the required customer access controls. Particulars of the configuration would vary with the system being employed and would be within the ability of one skilled in the art.

This software component resides on the application server of the Full Motion Portal 260.

3. Sun Java J2SE V1.2.2-05a

This software is a development kit and runtime environment for the Java applications. As noted above, Java allows the delivery of dynamic content to the User.

This software was selected over other server-side technologies due to its open standards, portability over competing technologies, performance, plus interoperability with the Sun O/S environment.

For this software, the most important aspect of the configuration was the class path information, which specifies where all Java libraries are located.

4. TCL and Expect Scripting Languages

These scripting languages were installed to execute script commands to import content to the video server. These two packages were chosen due to the developers' Familiarity with them, plus their capabilities. No configuration was required other than standard installation.

5. Java Cryptography Extensions V1.2.1

This software is a set of Java libraries allowing the encryption of e-mail passwords for customers. The Java Cryptography Extension (JCE) 1.2.1 also provides a framework and implementations for:

symmetric bulk encryption, such as DES, Triple DES, RC2, and IDEA;

Encryption is the process of taking data and a short string (a key), and producing encoded data meaningless to a third-party who does not know the key. Decryption is the inverse process: that of taking encoded data and a short key string, and reproducing the original data;

symmetric stream encryption, such as RC4;

asymmetric encryption, such as RSA; “Symmetric” encryption techniques use the same key for both encryption and decryption. “Asymmetric” encryption techniques use a pair of unlike keys, one for encryption and another for decryption, making it more secure (even if the key used to encode a file is obtained by an attacker, the encoded file cannot be decoded);

password-based encryption (PBE). PBE derives an encryption key from a password. To make the task of getting from password to key more time-consuming for an attacker, most PBE implementations will mix in a random number, known as a salt, to create the key; and

Key Agreement. Key agreement is a protocol by which 2 or more parties can establish the same cryptographic keys, without having to exchange any secret information.

The JCE also includes key generation routines for these techniques, as required.

This software was chosen as it is the standard industry cryptography package for Java. Configuration required for this software was none other than standard installation.

6. Apache Xalan XSL-T Engine V1.0.3

Xalan is an XSLT processor for transforming XML documents into HTML, text, or other XML document types. It implements the W3C Recommendations for XSL Transformations (XSLT) and the XML Path Language (XPath). It can be used from the command line, in an applet or a Servlet, or as a module in other program.

The system of the invention uses this third party software to transform XML documents, which are returned from the content database, into a user experience format defined by style sheet (XSL) files. This allows the system to clearly separate presentation from content and to allow different teams with different technical skill levels to administer both sides of the user experience equation of format (XSL) and data (content administration).

This software was chosen mainly because it is open source, its API was available in a Java format, it was designed by a reputable company and it seems to be becoming the defacto Internet standard.

The configuration required for this software was only basic installation.

7. Apache Xerces XML Parser V1.1.1

Xerces is an API available within Java for allowing Java programs to easily read, write and otherwise manipulate XML data. Content assets stored within the database for the system were done in XML format and an API was needed for parsing this data for the purposes of manipulation and finally presenting within a browser environment.

The Xerces XML Parser goes hand in hand with the Xalan transformation engine; they are both produced by the same company and are available as open source. This software was chosen for the same reasons as the Xalan XSL-T Engine.

The installation required for this software was only basic installation.

8. Endymion Sake Mail V1.0.36

Saké Mail is the server-side web site tool that provides full-featured email capabilities to web users. Saké Mail is integrated into the system architecture through a Servlet mechanism.

This product is customizable for a user interface and configuration file perspective using XML and XSL technologies. This capability was the major reason for selecting this tool to be integrated within the system. Rather than coding a client e-mail application from the ground up it was decided to include a third party tool for this functionality. Saké Mail handles user logins to the mail server. Sake Mail is capable of communicating with both IMAP and POP3 mail servers, and uses SMTP to send messages.

With Saké Mail, system Users can:

send and receive email from a clean and well-designed interface that is fully customizable;

receive attachments of any kind, including in-line image attachments and HTML-encoded messages;

send attachments of any kind;

organize messages into folders and sort messages arbitrarily; and

store address aliases and mailing lists.

The configuration required for this software related to its presentation to the customer and also, the activation of various features.

9. go.com TROVE Utilities Library V1.0.3

This JAVA utility class was obtained for the purposes of helping create a Timed Cache class for performing basic caching functionality within the system. Rather than coding everything from scratch this class helped provide the basic building block for a timed cache class thereby reducing development time.

This specific software was chosen because of the low price and since it provided the required functionality. The configuration required for this software was only basic installation.

10. fooware.com FTP Client Library

This JAVA utility class was obtained for the purposes of performing FTP (file transfer protocol) operations on files throughout the system. Rather than coding everything from scratch this class helped provide the basic FTP interface requirements thereby reducing development time. The FTP is the protocol used on the Internet for copying files from one device to another.

This specific software was chosen because of the low price and since it provided the required functionality. The configuration required for this software was only basic installation.

11. O'Reilly Servlet Utilities Library

This JAVA utility class was used within the DataHouse and the Command Line Interface (CLI) portions of the system for helping obtain data in a multi-part form request. A multi-part form request is used within the system for allowing a User to download a locally stored XML or zip file for manual content entry into the system database from a browser based application. Rather than coding everything from scratch this class helped provide the multi-part form request HTTP interface, thereby reducing development time.

This specific software was chosen because of the low price and since it provided the required functionality. The configuration required for this software was only basic installation.

12. Ronald Tschaler HTTP Client Library V0.3-2

This software emulates a Web browser to establish connections between servlets. HTTP (HyperText Transfer Protocol) is the underlying protocol used by the World Wide Web, defining how messages are formatted and transmitted, and what actions Web servers and browsers should take in response to various commands. For example, when a URL address is entered into a Web browser, the Web browser sends an HTTP command to the Web server directing it to fetch and transmit the requested Web page.

This JAVA utility class was used within DataHouse and the Command Line Interface (CLI) portions of the system for communicating and sending data between Servlets. This package provides a complete HTTP client library. It currently implements most of the relevant parts of the HTTP/1.0 and HTTP/1.1 protocols, including the request methods HEAD, GET, POST and PUT, and automatic handling of authorization, redirection requests, and cookies. Furthermore, the included Codecs class contains coders and decoders for the base64, quoted-printable, URLencoding, chunked and the multipart/form-data encodings.

Rather than coding everything from scratch this class helped provide the multi-part form request HTTP interface and other HTTP communication mechanisms thereby reducing development time. This specific software was chosen because of the low price and since it provided the required functionality. The configuration required for this software was only basic installation.

The invention is currently being implemented with Oracle Video servers 272, though more advanced video servers could be used. The hardware platform used for the Oracle Video server 272 is a Digital Equipment Corporation (DEC) Alpha 4100 server. This server offers:

symmetric multi-processing (SMP) design;

capacity for up to four CPUs (Central Processing Units);

capacity for up to 8 Gbytes of ECC protected RAM (random access memory);

64-bit RISC architecture;

a 144-bit data bus (128 bits for data and 16 for ECC) and a separate 40-bit command/address bus;

system bus bandwidth of 1.1 Gbytes per second with a memory latency of 120 nS; and

redundant power. The configuration required for this hardware was basic set-up and installation, which included software and network interface components.

The video server 272 is supported by two pieces of software:

1. Digital Equipment Corporation (DEC) operating system OSF1 Revision V4.0, Version 878.

This software was selected due to the fact that it was intended for use on the DEC Alpha 4100 server. The configuration required for this software was basic installation on the server.

This software component is the foundation for the hardware component of the Oracle Video Server 272, which is one of the components of the Full Motion Portal 260.

2. Oracle Video Server V3.1

This software component is used to deliver the video content, such as video-on-demand content to the viewer. This software was chosen due to its capabilities at the time of purchase, which are useful today in a limited sense for a small-scale deployment.

The configuration required for this software was basic installation, plus selection of various options for the delivery of the video content.

This component resides on the Oracle Video Server 272 of the Full Motion Portal 260.

The preferred system of the invention was also implemented using a set top box (STB) 266. There are many different makes and models of STBs currently available which could be used to implement the invention. The system of the invention only requires a generic STB with a Web browser, which can support customization by receiving HTML pages downloaded from the portal downloading. In particular, the invention has been implemented with each of the following STBs:

1. PACE acTIVe 2875;

2. PACE DSL 3875; and

3. PACE DSL 4000.

Each of these STBs includes the following features as a minimum:

1. a RISC (Reduced Instruction Set Computer) processor. A RISC processor is a type of microprocessor that recognizes a relatively limited number of instructions. This simplicity allows them to execute their instructions very quickly, making them well suited for dedicated real-time applications. Because of the simplicity, they include fewer transistors than more complex microprocessors, making them cheaper to design and produce;

2. MPEG 1 and MPEG 2 video decoder; MPEG (Moving Picture Experts Group) refers to a certain family of digital video compression standards and file formats, which generally produces better-quality video than competing formats. MPEG files can be decoded by special hardware or by software. MPEG achieves a high compression rate by considering only the changes from one frame to another, instead of each entire frame.

There are a number of MPEG standards currently available and others are expected to become available over time;

3. Ethernet interface (10BaseT); this provides the interface to the transmission network for broadband downstream video data and bi-direction control information; Ethernet (10 base-T) is a local-area network (LAN) protocol that uses a bus or star topology and supports data transfer rates of 10 Mbps. Faster versions of Ethernet are now available including 100Base-T which supports data transfer rates of 100 Mbps and Gigabit Ethernet which supports data rates of 1 gigabit (1,000 megabits) per second. However, 10 base-T is sufficient for the implementation of the invention.

Other LAN architectures and protocols are also available, which could be used to implement the invention. One skilled in the art could easily identify and implement such alternatives in view of the teachings herein.

4. NCFresco Web browser; and

5. OC-9000 operating system.

The most advanced of these three set top boxes, the PACE DSL 4000, has a 56 MHz Cirrus Logic 7500FE RISC processor with 64 MHz memory. It also includes:

1. Macrovision Anti-taping technology for Pay Per View applications;

2. near CD quality 32 bit (16 bits per channel) stereo output; which can be directly connected to existing hi-fi equipment;

3. support for European and North American television standards;

4. support for a wide range of video and audio standards;

5. 4 K bytes of non-volatile random access memory for storing configuration data, customer profile and short cuts; Ethernet MAC address and a unique identifier for traceability;

6. positions for a pair of 16 bit wide 32 M bit read only memory (ROM) chips to store boot and operating software;

7. 16 M bytes of 60 US EDO (Extended Data Out) DRAM (Dynamic Random Access Memory);

8. up to 32 K color graphics on a 720×576 screen mode;

9. 38 button infra red (IR) wireless handset;

10. PS/2 ports for keyboard and mouse; and

11. serial and parallel interfaces for the connection of RS232 devices, computer printers, and other peripherals.

The preferred embodiment of the invention was implemented with a personal computer 268, but as noted above, any computing device capable of running a Web browser could be employed. No other configuration was required.

### Head-End Equipment

The invention may also be used to offer television and radio services to the customer. The head-end equipment 274 that would be required to offer this service, called PCTV, is separate from the Full Motion Portal 260, but can be supported using the same software package. Note that this service is not generally available to those customer with PCs and STBs; PCS is required.

PCTV will function efficiently if it is the only program open and running on a User's machine with the following set up. For the implementation of the system described herein, the PC 268 should have at least the following hardware:

Intel PII 266 MHz processor

64 MB Ram

8 MB Video Card

10 Mbps Ethernet Card

The PC should also have the following software:

For Win95 DirectX Software is required (Directx 8.x is required);

Microsoft Windows 95 or 98, Win NT, and Win 2000; and

iMagicTV PcVu 3.0 or similar software.

The preferred embodiment of the Head-End Infrastructure 274 to support PCTV includes a Dell PowerEdge 2550 Server (for Microsoft Windows Media Services 4.1) to distribute content. This server:

supports up to two microprocessors running at 1.26 GHz;

up to 4 GBytes of RAM;

up to five 73 GByte 8C8I hard drives; and

support for external memory storage and tape backup.

The Head-End Infrastructure 274 also includes a Pinnacle StreamFactory X2 Encoder. This is a software and hardware system intended to provide broadcast-quality video on broadband networks. It will encode virtually any video or audio input into Real™, Windows™ or Quick Time formats.

The Head-End Infrastructure 274 is supported by the following software:

Microsoft Windows Media Services 4. 1;

ITO client/agent installed;

Empire client/agent installed; and

Microsoft Windows 2000 SP2.

While particular embodiments of the present invention have been shown and described, it is clear that changes and modifications may be made to such embodiments without departing from the true scope and spirit of the invention. For example, although certain manufacturers and Content Providers may have been referred to herein, the invention is not limited to any of these parties.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, personal digital assistants, Internet or two-way pagers, satellite telephones, Internet-ready telephones or other Internet, television or telephony appliances. Again, such implementations would be clear to one skilled in the art, and do not take away from the invention.

What is claimed is:

1. A method of organizing access to various multimedia services comprising the steps of:
defining a multiple axis framework;
locating each said multimedia service within said framework; and
allowing a User to select a desired one of said multimedia services by identifying coordinates with respect to one or more of said axes.

2. The method of claim 1 wherein said various multimedia services include services provided via various communication networks.

3. The method of claim 2 applied to converging networks, thereby integrating access to make content planes transparent to User.

4. The method of claim 2 applied to converging networks, whereby End Users do not have to shift paradigms, or be aware of which plane they are on and where they want to go, in order to change content selection.

5. The method of claim 2 wherein said multiple axes comprise three axes.

6. The method of claim 5 wherein said three axes comprise: mode, Provider and theme axes.

7. The method of claim 6 comprising the step of presenting different layers of said multiple axis framework to said User.

8. The method of claim 7 wherein said step of presenting comprises the step of presenting different layers of said multiple axis framework to said User via a graphic user interface (GUI).

9. The method of claim 7 wherein the ordering of said layers may be varied.

10. The method of claim 9, further comprising the steps of:
responding to a desired one of said multimedia services being selected by a User, by:
switching the input of said selected service to an output; and
converting the format of said selected service as required to suit said output.

11. The method of claim 10 wherein said step of converting is performed using a software driver with a common API (Application Programming Interface).

12. The method of claim 10 wherein said step of converting comprises the steps of:
converting the format of said selected service to an intermediate (meta) format; and subsequently
converting the format of said selected service from said intermediate (meta) format as required to suit said output.

13. The method of claim 12, further comprising the step of handling the logistics of billing and monitoring usage of services in an integrated manner.

14. The method of claim 2, wherein said various communication networks include an Internet network.

15. The method of claim 2, wherein said various communication networks include a video on demand service.

16. The method of claim 2, wherein said various communication networks include a public switched telephone network.

17. The method of claim 2, wherein said various communication networks include a broadcast network.

18. A multi media server comprising:
means for defining a multiple axis framework;
means for locating each said multimedia service within said framework; and
means for allowing a User to select a desired one of said multimedia services by identifying coordinates with respect to one or more of said axes.

19. A multi media system comprising:
an End User terminal;
a Service Provider; and
a communication network connecting said End User terminal and said Service Provider;
said Service Provider being operable to:
define a multiple axis framework;
locate each said multimedia service within said framework; and
allow a User to select a desired one of said multimedia services by identifying coordinates with respect to one or more of said axes.
